(19) United States
(12) Patent Application Publication
(10) Pub. No.: US 2008/0195437 A1
(43) Pub. Date: Aug. 14, 2008

(54) System and Method for Independently Representating Multiple Shareholders in the Sale of a Business

(75) Inventors: William Paul Koenig, Denver, CO (US); Mark B. Vogel, San Francisco, CA (US); Jason Mendelson, Boulder, CO (US)

Correspondence Address: Neugeboren O''Dowd PC, 1227 Spruce Street, SUITE 200, BOULDER, CO, 80302, US

(73) Assignee: Shareholder Representative Services, LLC, Denver, CO (US)

(21) Appl. No.: 12/022,856

(22) Filed: Jan. 30, 2008

Related U.S. Application Data
(60) Provisional application No. 60/889,016, filed on Feb. 9, 2007.

(51) Int. Cl. G06Q 10/00

(52) U.S. Cl. 705/7; 705/1

(57) ABSTRACT

A system and method by which an independent party serves as a representative of the shareholders or equity holders of a privately-held company for purposes of interacting with the purchaser of the privately-held company, the shareholders, governmental agencies and certain other third parties, following the closing of such merger and acquisition transaction.

### CROSS REFERENCE TO RELATED APPLICATION

This application is based upon, and claims priority to U.S. Provisional Patent Application No. 60/889,016, entitled Method of Independent Representation of Multiple Shareholders, filed Feb. 9, 2007. The entirety of such provisional patent application, including all exhibits and appendices are incorporated herein by reference.

### FIELD OF THE INVENTION

This invention relates to a system and method that allows for an independent and professional representative to represent shareholders of a privately-held business after that business has been acquired by or merged with or into a third party.

### BACKGROUND OF THE INVENTION

Business mergers and acquisitions have been occurring for centuries. The parties to those transactions can be either publicly held or privately-held companies with any number of shareholders or equity holders. As a part of the transaction, the purchaser will typically require the seller and possibly the shareholders to: (i) make a number of representations and warranties regarding the seller's business and certain risks related to that business, (ii) covenant to undertake certain actions, and (iii) refrain from undertaking certain other actions. When the seller is a privately-held company, the purchaser will also typically require that there be certain protections built into the acquisition agreement to protect the purchaser if any of those representations, warranties or covenants are breached or otherwise turn out to be false, incomplete or misleading or if the purchaser otherwise suffers certain specified damages for which it is entitled to be compensated under the terms of the acquisition agreement.

For instance, the purchaser will typically secure a right to be indemnified by the seller, and/or the shareholders, for certain damages suffered by the purchaser, including as a result of a breach or misrepresentation. Additionally, the purchaser will often hold back a portion of the purchase price in a separate escrow account. That escrow account is typically managed by an independent party and is to be paid to the purchaser in the event that damages are suffered. In the event there are no such damages or the amount of any damages is less than the balance in the escrow account, the escrow agent will normally release the remaining balance of the escrow account to the seller or the shareholders of seller at the end of a designated period following the closing of the acquisition.

A unique challenge arises when the seller is a privately-held company with multiple shareholders. The challenge arises because the purchaser will want a single party to represent all shareholders (or former shareholders) of the seller following the closing of the acquisition transaction should there be any need for communications between the purchaser and the shareholders.

Such communications typically include, but are not limited to, claims regarding any breach of a representation, warranty or covenant, assertions regarding rights to all or a portion of the amount held in escrow, communications regarding purchase price adjustments and the related calculations (for instance as may be based on closing cash or “working capital” balances), communications regarding the calculation of contingent future payments, or any other communications that are required between the purchaser and the seller or its shareholders. In these situations, the purchaser often cannot communicate with the seller because the seller has either been merged into or acquired by or merger with or into the purchaser (in which case the purchaser would be effectively communicating with itself), or the seller has ceased operations and has either been wound down or is in the process of winding down. The purchaser also typically will not want to take on the burden and responsibility for contacting multiple shareholders regarding any such disputes, claims or communications nor be responsible for determining the will of the shareholders when there are differing opinions.

Historically in this situation, the purchaser required a single party affiliated with seller or one or more of its shareholders to be a representative of all of the shareholders following closing of the transaction. Such party could be one or more shareholders of the seller, a former executive of the seller or a committee appointed by the seller. In many cases, this presented a problem because either (i) each of the shareholders is either unwilling, or would prefer not to, serve as this representative; or (ii) the shareholders cannot agree on who that representative should be. The shareholders may not be able to agree on a representative for several reasons, including a lack of trust of other shareholders, actual or perceived conflicts of interest, differing financial interests in any remaining payments, and other similar reasons.

Similarly, there are many reasons why a shareholder may not be interested in serving as the representative. For instance, the shareholder could be concerned that serving as the representative would expose it to liability. Additionally, following a closing, shareholders are often interested in minimizing their ongoing involvement with the seller and the acquisition transaction and do not want to be responsible for the administrative and other burdens that typically come from serving as the shareholder representative. Moreover, shareholders often do not want one of the other shareholders to serve as the representative because of actual or perceived conflicts of interest.

Based on research and information provided by institutional stockholders that hold stock of portfolios of privately-held companies and that have engaged in numerous merger and acquisition transactions, there remains an ongoing and unmet need for a system and process that provides for a professional and independent agent to serve as an independent representative of the seller and/or its shareholders regarding such post-closing communications with the purchaser. Accordingly, a method is needed to provide such consolidated and independent representation of shareholders when their privately-held company is acquired.

### SUMMARY OF THE INVENTION

Exemplary implementations of the present invention that are shown in the drawings are summarized below. These and other implementations are more fully described in the Detailed Description section. It is to be understood, however, that there is no intention to limit the invention to the forms described in this Summary of the Invention or in the Detailed Description. One skilled in the art will recognize that there are numerous modifications, equivalents and alternative constructions that fall within the spirit and scope of the invention as expressed in the claims. And while various embodiments are described herein, except where specifically noted, it is not the intention to limit any of the claims to the specific embodiments.

Disclosed herein is a method and associated system by which an independent party serves as a professional representative of the shareholders or equity holders of a privately-held company following the closing of a merger of that company into another or the acquisition of that company by another for the purpose of (A) interacting with (i) the purchaser of the privately-held company following the closing of such merger or acquisition transaction, (ii) the independent escrow bank, if applicable, (iii) the former shareholders or equity holders of the selling company, and (iv) any other third party applicable to the transaction, and (B) performing certain other specified obligations of the shareholder representative under the terms of the applicable transaction documents.

In a first embodiment, a method of representing shareholders of a target company in acquisition-related dealings after the target company has been acquired by a purchaser, the method comprises determining whether the target company is privately-held, determining whether the target company has a plurality of shareholders, entering into an agreement between the target company and the purchaser whereby the purchaser agrees to acquire the target company and engaging a shareholders' representative to represent the plurality of shareholders of the target company in one or more acquisition-related dealings, and discharging one or more duties as the shareholders' representative.

In one implementation, the interaction of the independent representative includes representing the shareholders in discussions or negotiations related to a dispute or claim regarding funds held in escrow following the closing. In another implementation, the interaction of the independent representative includes representing the shareholders with respect to disputes or claims regarding any actual or alleged breach by the privately-held company or its shareholders of any representation, warranty or covenant related to the merger or acquisition transaction. In yet another implementation, the independent representative transmits correspondence from the purchaser to one or more shareholders. In another implementation, the independent representative serves as attorney-in-fact for the shareholders for purposes of any discussions, negotiations, communications and any related settlements. In another implementation, the independent representative communicates with the shareholders regarding such matters, answers any questions they may have about the post-closing process, updates their contact information, and/or delivers periodic reports or statements regarding the status of any claims or disputes, the amount of time remaining in the escrow period and/or their respective portions of any remaining balances in any escrow accounts. In another implementation, the independent representative conducts necessary research regarding any such matters. In still another implementations, the independent representative engages attorneys or other representatives as necessary, and takes such other actions as the independent representative determines to be in the best interests of the shareholders.

In another implementation, the independent representative automates the process of maintaining and distributing information to the shareholders regarding any disputes, escrow balances, remaining escrow periods and similar information by maintaining a database of such information and allowing for automated delivery of periodic reports. In another implementation, the independent representative makes available to the shareholders a secured website that allows them to log in with a password and user identification to allow them to access certain information or update their contact information at their convenience. In another implementation, the independent representative maintains a secure database of applicable information that allows for automated updating of escrow balances and related information and automated communications and delivery of statements to shareholders.

In general, the independent shareholders representative may serve as an attorney-in-fact for the shareholders for purposes of discussions, negotiations, communications and related settlements, hiring and retention of attorneys, accountants or other specialists on behalf of the shareholders, calculating any purchase price adjustments or contingent future payment amounts, and taking any other actions the representative deems necessary or advisable to take in representing the best interests of the shareholders following the closing of the merger or acquisition transaction. Various types of automated and/or interactive systems are also contemplated that perform or facilitate the method described herein. These would include, without limitation, automation of delivery of periodic statements, automated downloading of statement information from escrow agents, automated updates of escrow account balances for all shareholders and other similar functions.

The above-described implementations are for illustration purposes only. Numerous other implementations and details of the invention are easily recognized by those of skill in the art from the following descriptions and claims. The claims should not be construed to be limited to any particular embodiment described in the specification.

### BRIEF DESCRIPTION OF THE DRAWINGS

Various objects and advantages and a more complete understanding of the present invention are apparent and more readily appreciated by reference to the following detailed description and to the appended claims when taken in conjunction with the accompanying drawings. It will be understood by one of skill in the art that these transactions may take various forms and that the figures represent only several variations of such transactions.

FIG. 1 is a block diagram depicting an exemplary relational and transactional structure of a typical merger and acquisition transaction;

FIG. 2 is a block diagram depicting another exemplary relational and transactional structure of a merger and acquisition transaction;

FIG. 3 is a block diagram depicting an exemplary relational and transactional structure of a merger and acquisition transaction in which an independent representative represents the shareholders of the acquired company after the closure of such merger and acquisition;

FIG. 4 is a flowchart depicting an exemplary method that may be carried out in connection with one or more of the previous embodiments;

FIGS. 5-14 show a preferred system embodiment that implements a method in accordance with certain aspects of the present invention; and

FIG. 15 shows a flow chart of the various post-closing and post-engagement activities administered by the independent shareholders' representative.

### DETAILED DESCRIPTION

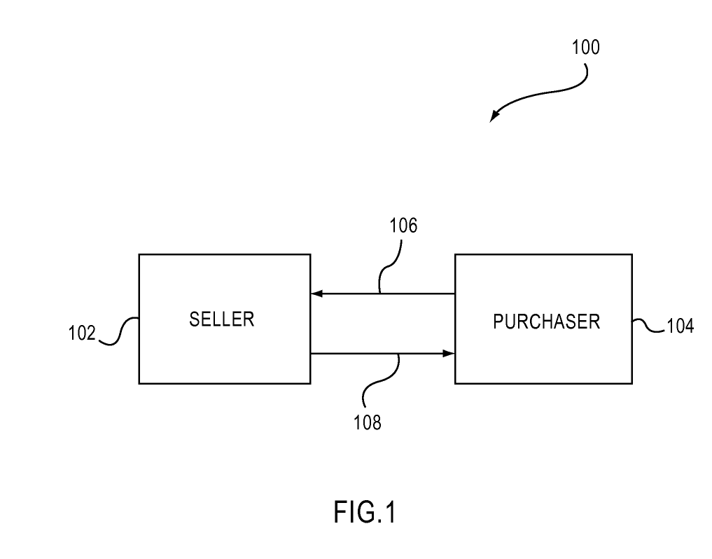

Referring now to the drawings, where like or similar elements are designated with identical or corresponding reference numerals throughout the several views, and referring in particular to FIG. 1, shown is a block diagram depicting the transactional relationships between interested parties in an exemplary merger and acquisition of a company.

FIG. 1 depicts a simple relational and transactional structure of a typical merger and acquisition transaction 100. Block 102 depicts the privately-held company that is being sold or merger into another entity (referred to herein as “seller”). Block 104 depicts the entity that will acquire the privately-held company 102 (referred to herein as “purchaser”). In its simplest form, the merger and acquisition transaction involves the transfer of money (or other assets) from the purchaser 104 to the seller 102 in exchange for the all of the stock or assets of the privately-held company (seller) 102. Vector 106 illustrates payment of the negotiated purchase price, in cash, stock or other forms of value, to the seller 102, and vector 108 illustrates transfer of the seller's entire stock or assets to the purchaser 104 in exchange for the purchaser's payment. It should be noted that while there are various other forms that such a transaction could take, FIG. 1 is meant to represent the basic structure of how some of such transactions are currently effected.

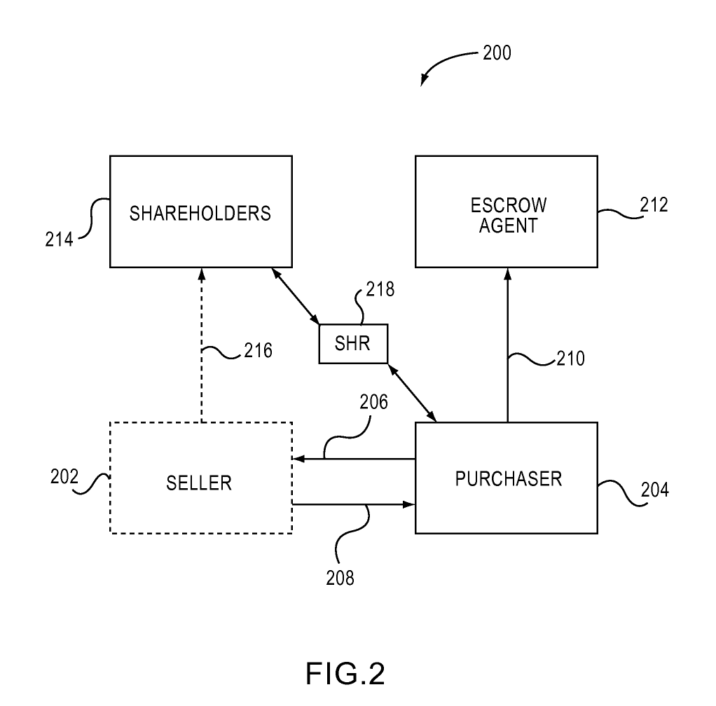

FIG. 2 depicts a more complicated relational and transactional structure of a merger and acquisition transaction 200. Block 202 depicts seller, and block 204 depicts purchaser. Vector 206 illustrates only a partial payment of the purchase price (again, in cash, stock or other forms of value) to the seller. In the transaction depicted in FIG. 2, the remainder of the purchase price is deposited in an escrow account, as illustrated by vector 210, and the escrow account is controlled by an escrow agent depicted in block 212.

A primary purpose of the escrow account is to protect the purchaser 204 against certain specified damages it may suffer in connection with the acquisition of the seller 202 following or in connection with the closing of the merger and acquisition transaction. Such damages include, without limitation, those arising from a misrepresentation, breach of covenant, breach of warranty, or other acts or omissions which materially reduce the value of the privately-held company (seller) 202 for which the purchaser 204 bargained. For example, if the seller 202 had represented that there were no pending litigation matters between seller 202 and any third party at the time of the closing, and then after the closing, the purchaser 204 discovered that there were in fact pending litigations between the seller 202 and third parties which exposed the seller 202 to significant potential losses in value, then the purchaser 204 would likely seek to collect damages for the seller's misrepresentation from the escrow account. Various other misrepresentations (intentional or unintentional) may also be discovered during the escrow period. The balance in the escrow account is meant to protect in part or in full against any financial implications of such miss-representations. If after a specified period of time, and as reflected in the escrow instructions (for example one year), the purchaser 204 has made no claims against the seller 202 or its shareholders 214, or the amount of any applicable damages from such claims are less than the balance in the escrow account, then the escrow agent 212 will be authorized to release the remaining escrow funds to the shareholders 214. As used in this application, the term shareholder, and other similar terms, is meant to include any equity holders or owners of a company, including, without limitation, any stockholders, members, partners or other owners of equity interests or derivative securities therein.

It should be noted that the depiction in FIG. 2 is meant to represent the situation that exists after the sale or merger of seller 202 has closed. In such a situation, the seller 202 often no longer exists as a legal entity unaffiliated with purchaser 204 because it is now a subsidiary of purchaser or has been merged into purchaser. What remains after closing the transaction are the individual shareholders of seller. Thus, seller 202 is represented in FIG. 2 by dashed lines to indicate that while certain interests or obligations exist during the post-closing escrow period that relate back to seller 202, it is the shareholders, operating through a shareholder representative 218, that will actually communicate with purchaser 204.

The escrow agent 212 receives instructions signed by both the representative of the shareholders 214 and the purchaser 204 which instructions identify when, and under what circumstances, money should be released from the escrow account and to which party.

Block 214 depicts the shareholders of the privately-held company (seller) 202 that is acquired by or merged with or into the purchaser 204. Typically, as part of, or shortly after the closing of the merger and acquisition transaction, the purchase price for the seller 202 is distributed, proportionally, to the seller's shareholders 214, as reflected in vector 216. However, when a portion of the purchase price is held back and placed in escrow, much time will have passed before the remaining portion of the purchase price will be distributed. Since the seller 202 may no longer exist as a separate independent entity (if, for instance, it has been dissolved or merged into the purchaser 204) the shareholders 214 lack an entity to represent their interests in disbursement of any remaining escrow consideration or the administration of duties and responsibilities after the close of the merger and acquisition transaction. Prior to the closing, the board of directors (or equivalent governing body if applicable) of seller 202 generally serves the function of representing the shareholders' interests, but such board generally goes away when the seller ceases to exist as a separate independent entity. Accordingly, there can be great confusion in the administration of such post-closure activity. As discussed above, in the past, one of the actual shareholders 218 was elected or volunteered to serve as a representative of the entire class of shareholders and administered the post-closing activity on behalf of the entire class of shareholders. At the conclusion of the escrow period, funds flow from the escrow agent to the shareholders and in the event of a claim, funds flow from the escrow agent back to the purchaser.

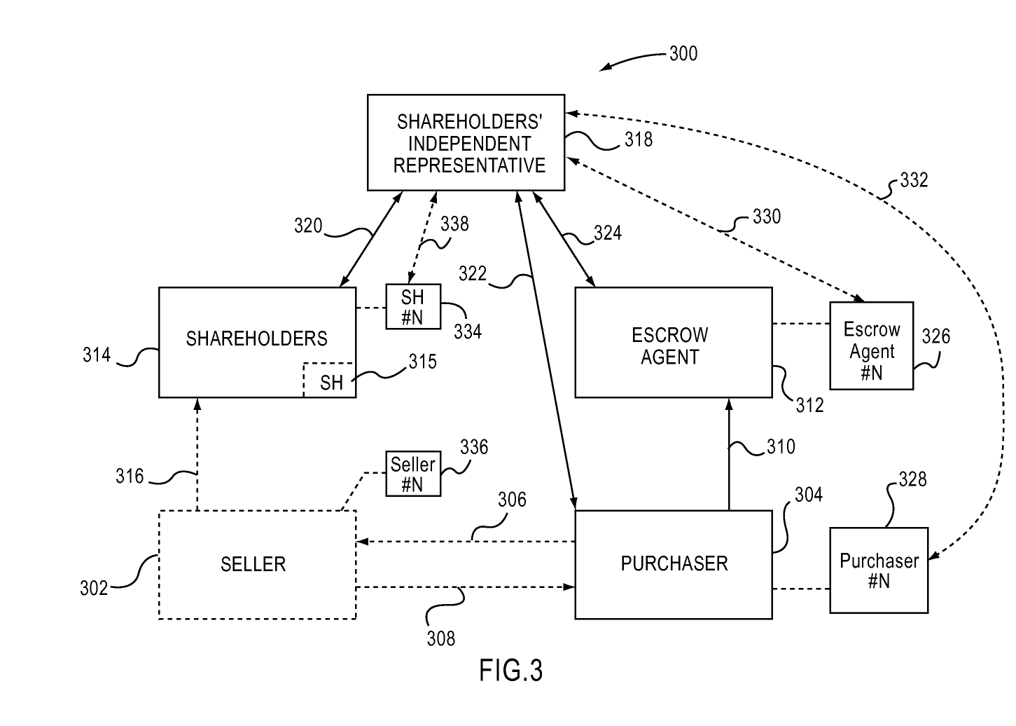

Referring now to the embodiment depicted in FIG. 3, a seller 302 and a purchaser 304 have engaged an escrow agent 312. A portion of the purchase price is transferred from the purchaser 304 to the seller 302 as illustrated by vector 306. The stock or assets of the seller 302 are transferred to the purchaser as illustrated by vector 308. A portion of the purchase price is held back from the seller 302 and is delivered to the escrow agent 312 to place in an escrow account, as illustrated by vector 310. The shareholders 314 receive a distribution of the portion of the purchase price transferred to the seller 302, typically on a proportional basis, as indicated by vector 316. After closing of the transaction, seller might not exist any longer as a separate entity independent of purchaser 304, and is thus shown as dashed lines to indicate that while certain interests exist during the post-closing escrow period that relate back to seller 302, it is the shareholders, operating through a shareholder representative 315 that communicate with purchaser 304.

In addition, FIG. 3 depicts the use of a shareholders' independent representative 318, who is appointed by the shareholders 314 to represent them and their interests in all transactions after the close of the merger and acquisition transaction. Shareholders' independent representative 318 takes the place of any individual shareholder representative 315. To discharge its responsibilities, the shareholders' independent representative 318 must communicate with the shareholders 314, the purchaser 304 and the escrow agent 312, as illustrated by the bidirectional vectors 320, 322, and 324, respectively.

Because the shareholders' independent representative 318 is a separate and distinct entity from any of the individual shareholders 314 and the seller 302, it can function as a shareholders' independent representative for multiple transactions. For example, the same shareholders' independent representative 318 may engage with multiple escrow agents, multiple purchasers, and multiple groups of shareholders. This is depicted in FIG. 3 as the parallel escrow agents 326, purchasers 328, shareholders 334, and sellers 336 and by respective vectors 330, 332, and 338. While there may also be multiple sellers 336, the communication is between shareholders' independent representative 318 and shareholders 314 and possibly 334.

By way of exemplary illustrations, the method disclosed herein is further described. A target company (also referred to herein as “the seller”) is sold to or merged into an acquiring company (also referred to herein as “the purchaser”) for an agreed-to amount of money or other forms of value, such as stock, bonds, or warrants. As part of the acquisition agreement, an escrow account is established with a certain percentage of the agreed-to amount of money or other value to be paid for the target company. The escrow account is managed by an escrow agent. The money in the escrow account is paid by the acquiring company into the escrow account. The escrow money is thereby held back from the shareholders of the target company as a security assurance to the acquiring company against certain damages, including from breaches of the representations and warranties given by the target company (and sometimes its shareholders) in the transaction or the covenants given during the transaction by the target company (and sometimes the shareholders) to the acquiring company. In addition, other terms and conditions that must be adhered to after the close of the transaction are documented in the acquisition agreement.

For purposes of illustration only, the following example is provided. The shareholders of the target company immediately prior to closing of the transaction consist of the following: Shareholder 1a holds a total of 25 percent of the target company. Shareholder 1b holds a total of 5 percent of the target company. Shareholder 2 holds a total of 35 percent of the target company. Shareholder 3 holds a total of 28 percent of the target company. Shareholder 4 holds a total of 6 percent of the target company. Shareholder 5 holds a total of 1 percent of the target company. In this illustrative example, Shareholder 1a and Shareholder 1b are managed by the same shareholder group. In this illustrative example, each shareholder is entitled to its pro-rata portion of the escrow balance when the escrow period expires.

The professional shareholder representative (also referred to herein as “the representative”) receives a fee for its services, which is typically payable at the close of the acquisition and amortized over the life of the transaction.

In one implementation of the method disclosed herein, an engagement letter is negotiated and executed between the target company, the major shareholders of the target company, and the selected shareholders' independent representative. In addition, the engaged independent representative reviews and is made a party to various acquisition documents. All of such transaction documents are stored by the shareholder' independent representative as part of the merger and acquisition transaction files.

The shareholders' independent representative receives information about the shareholders of the target company, including without limitation, their names, addresses, email addresses, percentage shareholdings, and wire transfer instructions. In addition, the representative attempts to update and keep track of contact information for all shareholder groups, as well as individual shareholders. Based on the shareholding percentage, the professional independent representative keeps track of each shareholder's pro-rata balance of the escrow amount, as may be adjusted upward or downward from time to time based on credits and debits to the account.

There may be other terms and conditions specified in the acquisition agreement. The shareholders' independent representative records all such terms and conditions in a system and sets various dates and triggers to monitor and track the performance of these obligations as specified in the acquisition documents.

An escrow brokerage account is maintained at a bank or escrow company. On a periodic basis (potentially daily), the representative downloads the transactions and balances from the escrow account and either reconciles the bank account or processes new transactions. In addition to the main escrow account, there may also be an associated expense escrow account for which the representative will perform similar accounting and monitoring processes. If an expense escrow is established, it is typically available to the representative to cover any expenses incurred in defending any claims made by purchaser or in otherwise administering the escrow account and the post-closing process.

From time to time, the purchaser may wish to file a claim against the escrow account. The purchaser will contact the representative and file the claim in accordance with specified instructions in the acquisition documents. The representative records each claim and independently evaluates the claim to determine if it is valid or not. If the representative determines that the claim is valid and that the claimed amount of damages are accurate, the representative will authorize the escrow agent to pay the purchaser the appropriate funds out of the escrow account. If the representative believes the claim is not valid, the representative will initiate a claim dispute. The representative establishes a claim monitoring and processing function to perform this function. When a claim is paid, the representative recalculates the pro-rata portion for each shareholder's share of the escrow balance. The representative files all documentation associated with a claim.

Investigation and disputes of claims may generate out-of-pocket expenses for the representative. As these expenses are incurred, the representative bills these expenses against the expense escrow or to the shareholders if no expense escrow is maintained. If an expense escrow is maintained, the representative will be reimbursed or pay for expenses out of the expense escrow periodically in accordance with the established escrow procedures.

In the event that the shareholder representative represents a particular entity or individual who is a former shareholder in multiple companies that have been sold or merged into another entity and the shareholder representative is the representative of the shareholders on each of such transactions, the shareholder representative would gather information from all such transactions on one report to be delivered to such shareholders. For instance, and by way of illustration only, if the shareholder representative is the representative of the shareholders of both Company A and Company B following their sales to Buyer X and Buyer Y respectively, and Shareholder T was a shareholder of both Company A and Company B, any reports or information delivered by the independent shareholder representative according to the methods described herein to Shareholder T would contain applicable information for both Company A and Company B. Such information would be separated for each such selling company, but would be included on one consolidated report.

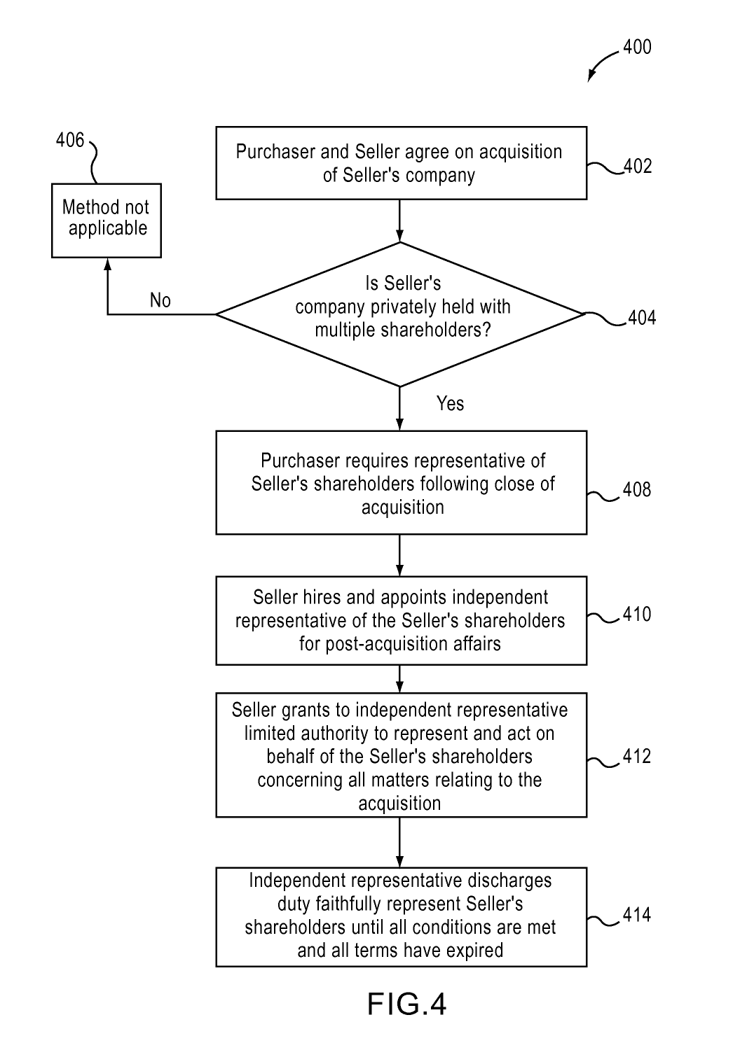

Referring now to FIG. 4, a process 400 in accordance with various aspects of the present invention is shown. In block 402 the purchaser, seller and shareholders enter into an agreement regarding a merger and acquisition transaction of seller to purchaser. In branch 404, the parties to the merger and acquisition determine whether the seller meets the required criteria for engagement of a shareholders' independent representative, i.e., the seller must be a privately-held company, and it must have multiple shareholders. If both requirements are not met, the disclosed method is not applicable as illustrated by the “no” branch of branch 404 extending to block 406.

If both requirements of branch 404 are met, then the process flow continues to block 408 where the purchaser requires the identification of a shareholders' representative to be the sole point of contact for the purchaser regarding matters relating to the transaction after the merger and acquisition transaction closes.

In block 410, the shareholders or the seller (with agreement of its shareholders) engages an independent representative to represent the shareholders in post-acquisition matters. In block 412, the shareholders or the seller grants to the shareholders' representative a limited power of attorney to represent and act on behalf of the shareholders with respect to specified matters related to the purchaser, the escrow agent, and the acquisition agreement for the period of such representation.

In block 414, the representative discharges its duties to the shareholders for as long as there are post-acquisition duties or obligations. In the event that the purchaser or the escrow agent makes any communications to the shareholders' representative, the shareholders' representative takes such actions it reasonably determines to be necessary or advisable to respond to such communications. By way of illustration, and not limitation, if the purchaser makes a claim alleging a breach of a representation or warranty alleging that the purchaser is, as a result, entitled to all or a portion of the amount held in the escrow account to compensate it for any resulting damages, the shareholders' representative could take any of the following actions as it deems necessary or advisable: (i) investigate the background related to such allegation, (ii) communicate with the shareholders to determine whether they dispute or agree with such allegation or damages, (iii) negotiate with the purchaser regarding such allegations or damages, (iv) engage independent counsel or advisers regarding such matter, (v) communicate with the escrow agent and authorize a release of certain funds if applicable, and (vi) take such other similar actions as may be necessary or advisable. The independent shareholders' representative would in most circumstances carry insurance to protect against any claims made against it for failure to adequately perform its functions as the shareholders' representative.

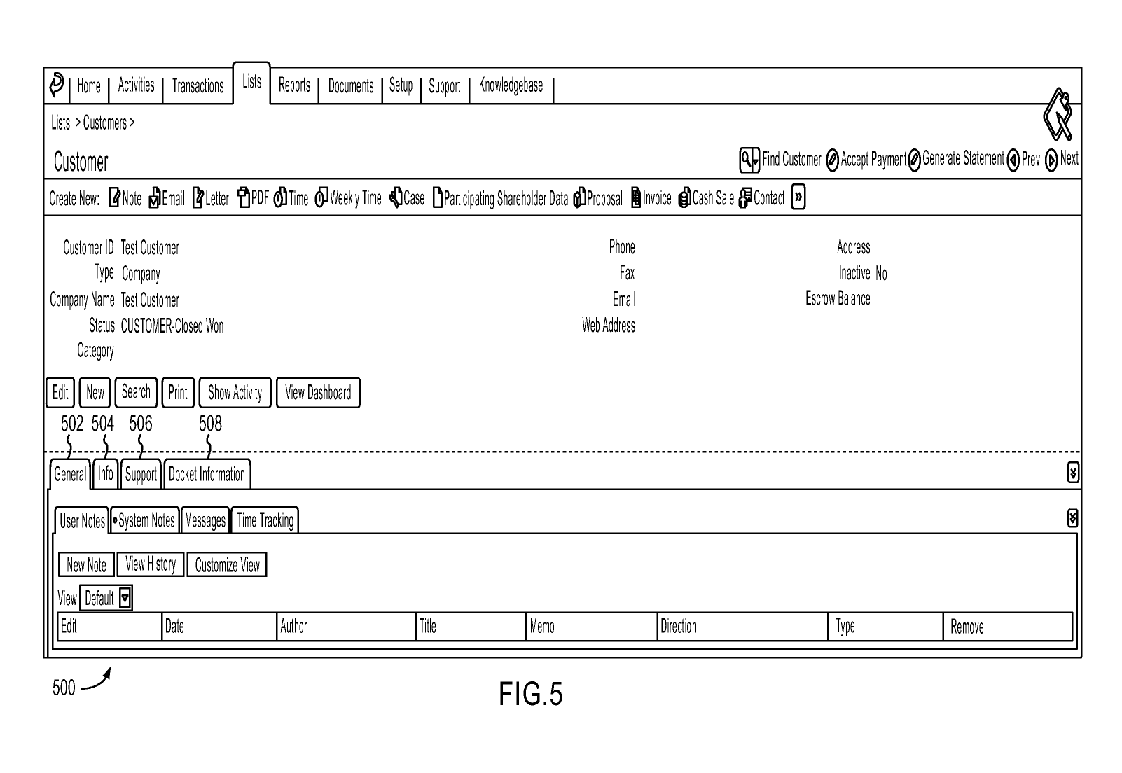

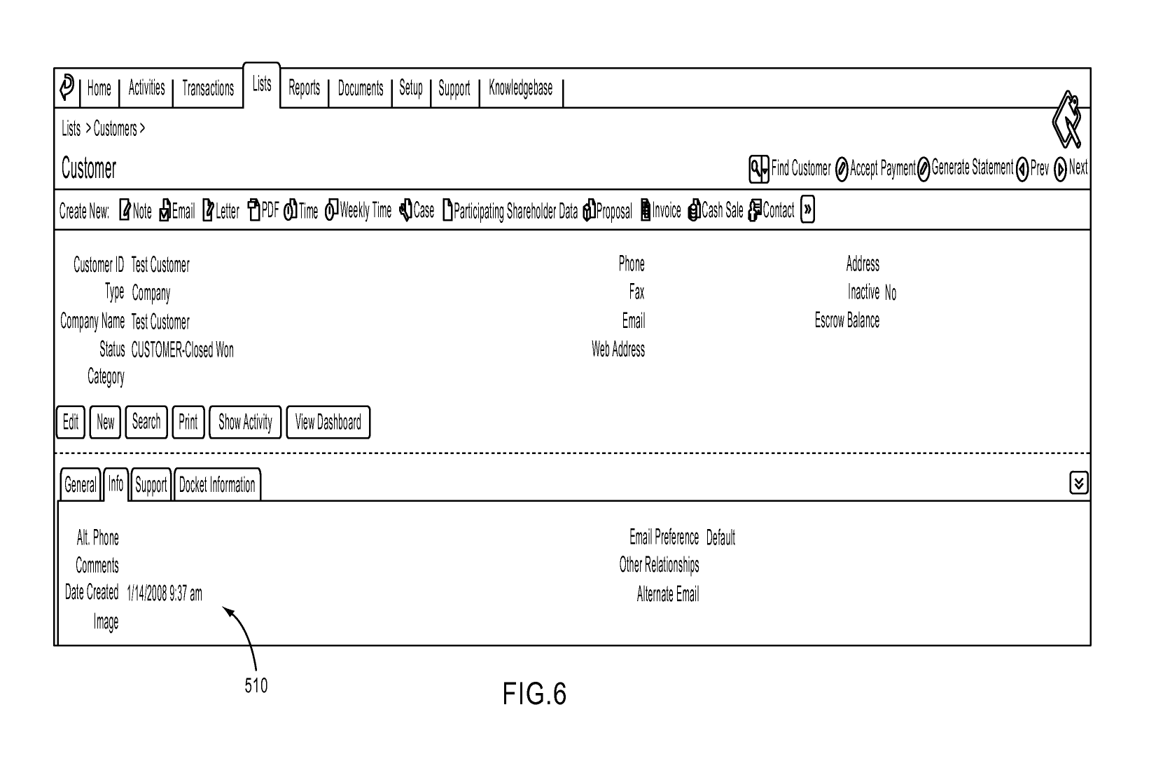

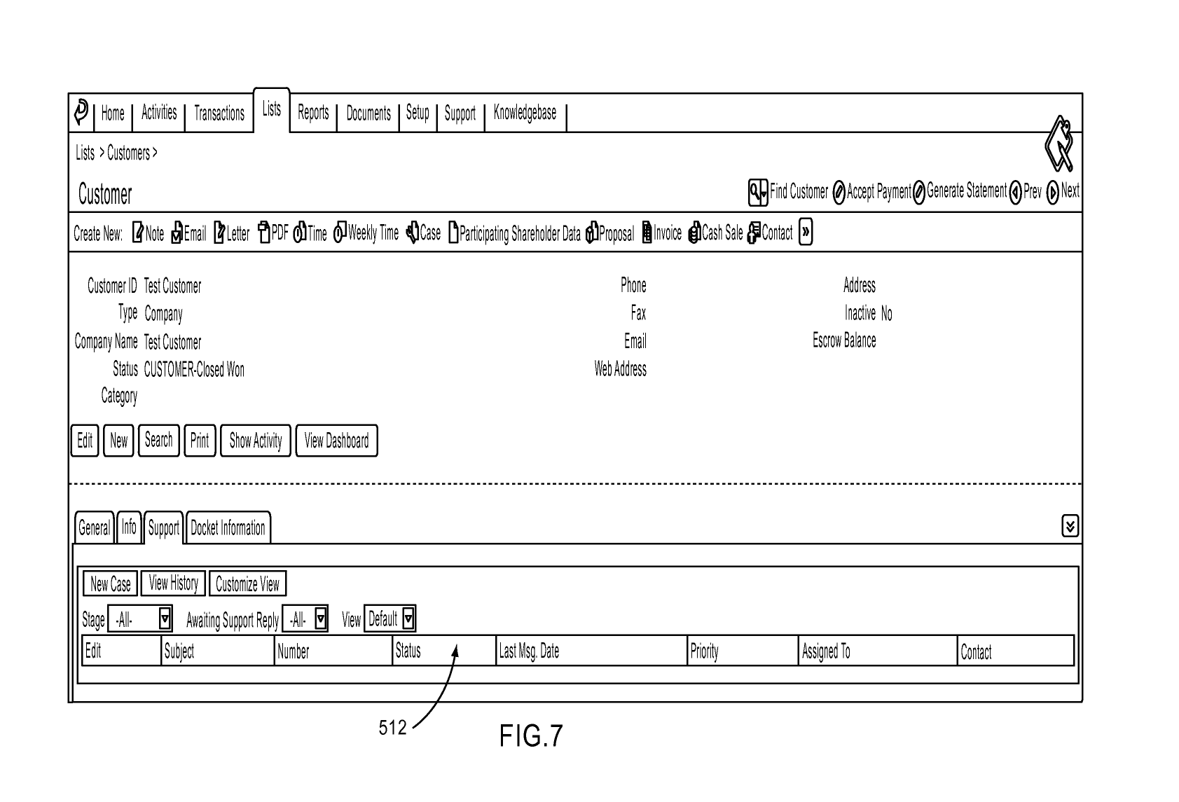

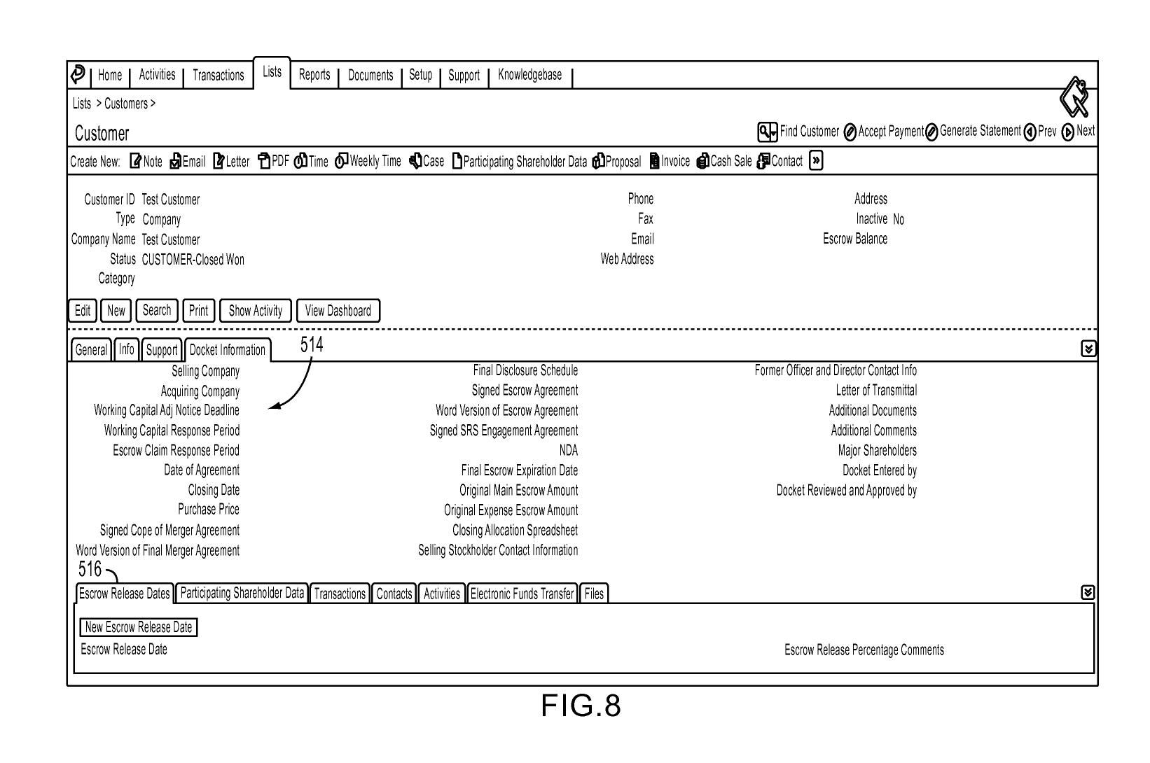

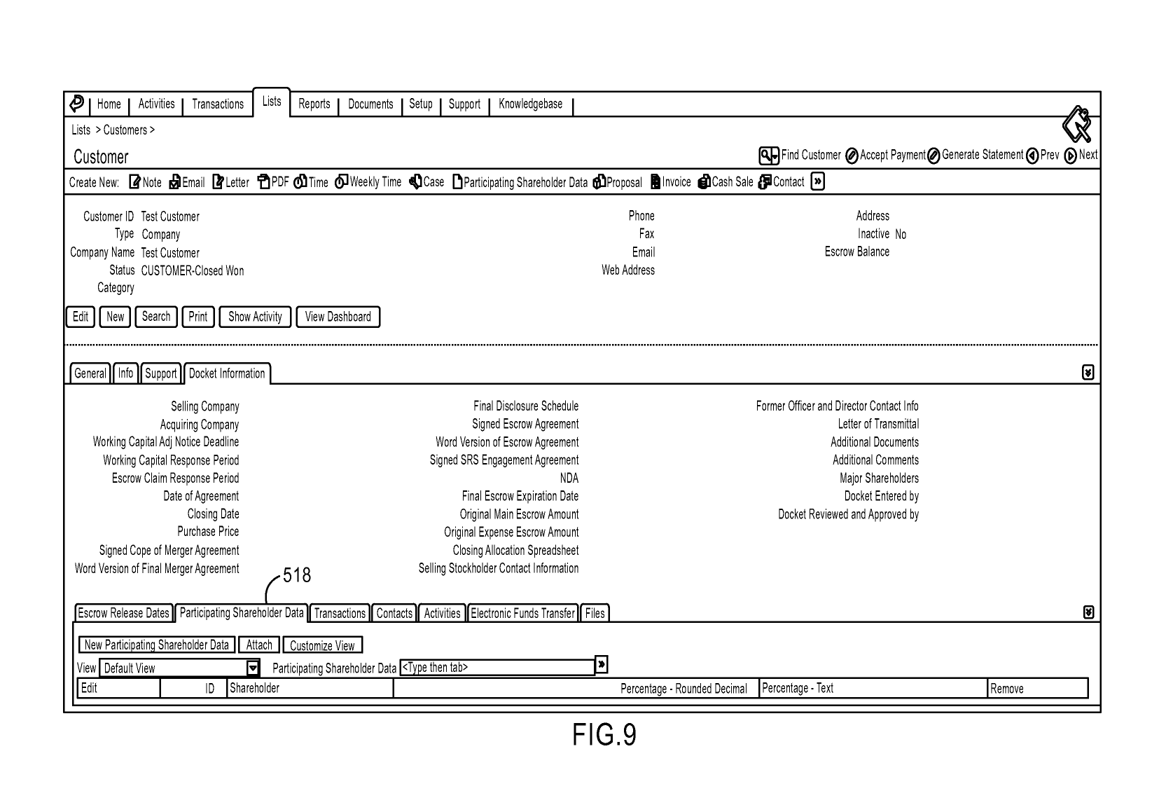

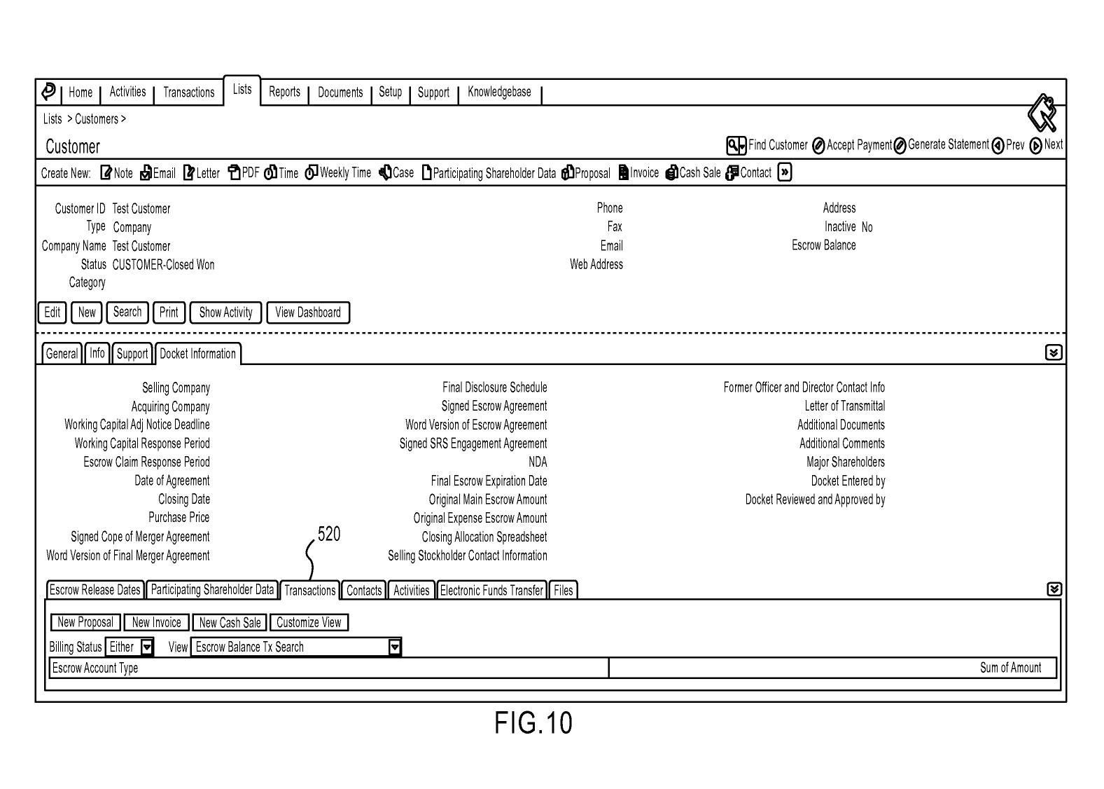

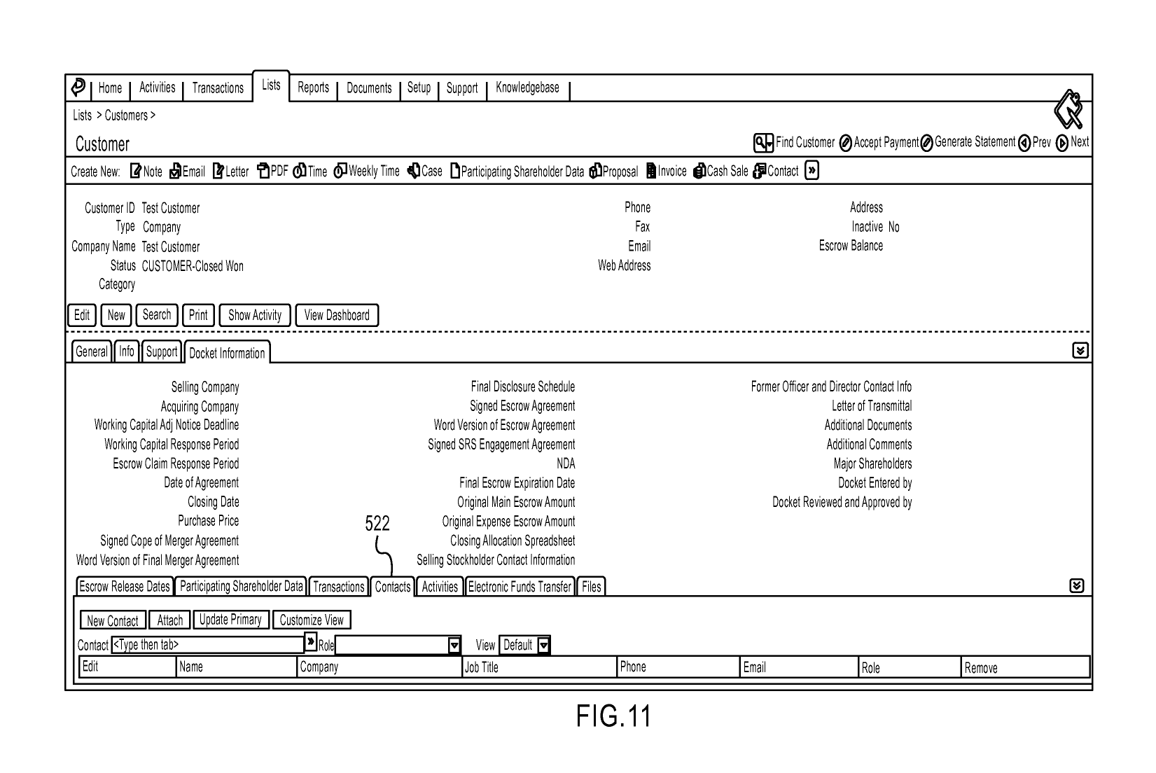

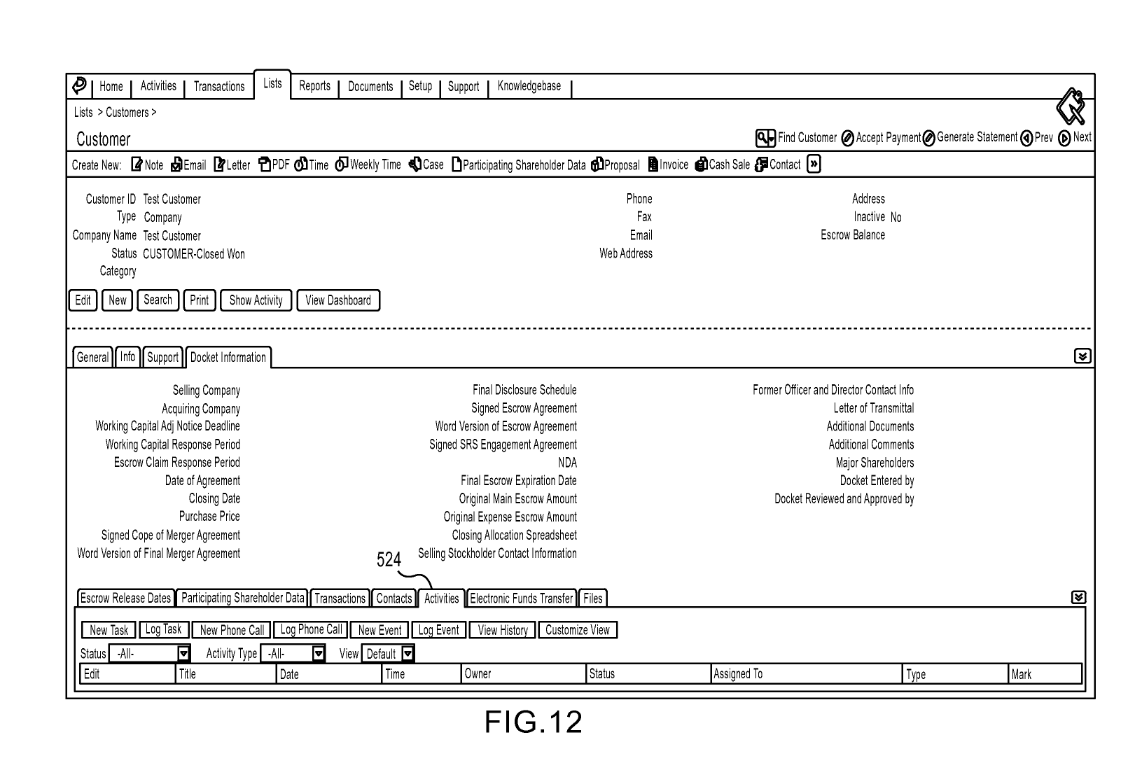

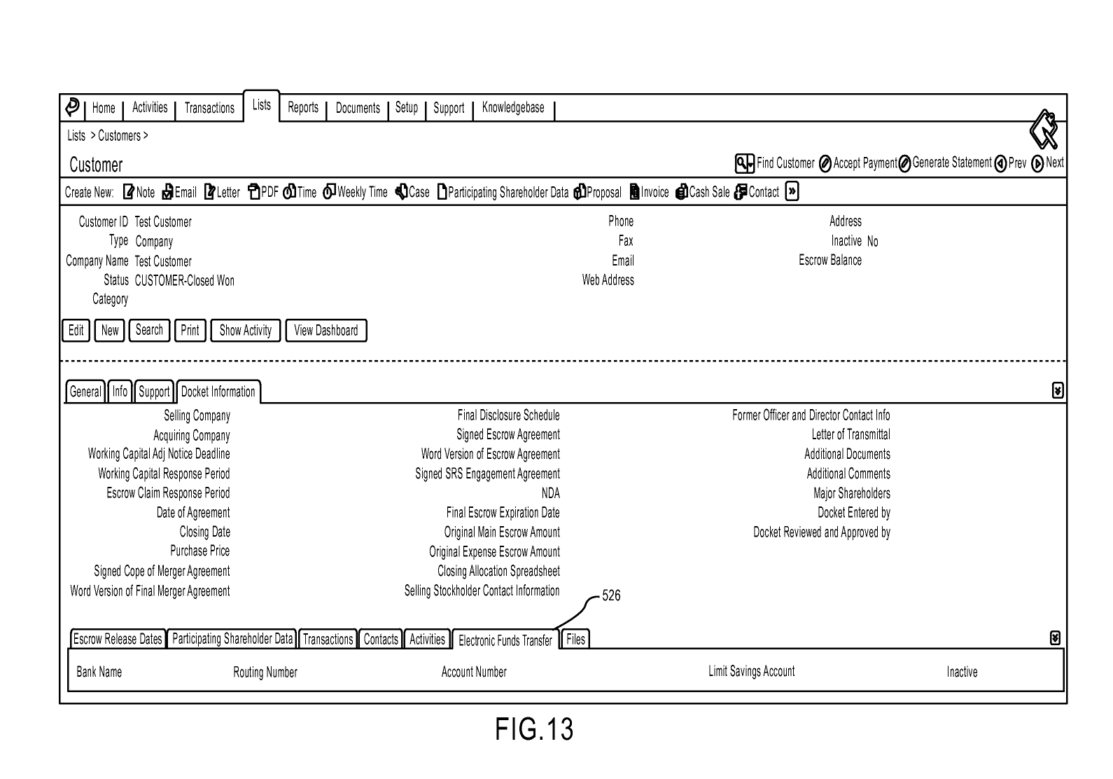

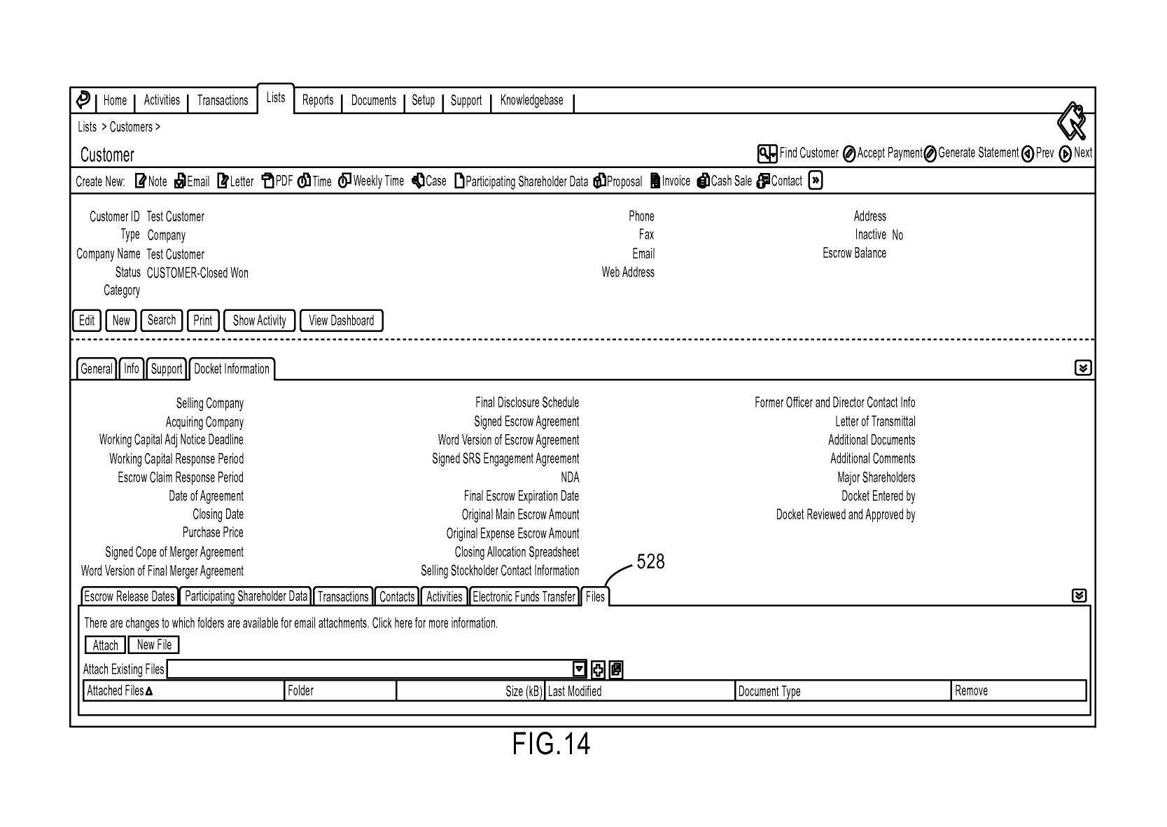

Referring generally to FIGS. 5-14, an exemplary embodiment of an automated system in accordance with various aspects of the present invention is shown. With respect to any particular transaction on which the independent shareholders' representative might be engaged, various information about the transaction can be displayed through a user interface 500. The user interface includes such groupings of information such as general data 502 about the particular transaction, contact information 504, support information 506 and docket information 508. Information screen 510 may contain contact data about the company or any of its shareholders. Support screen 512 may contain a running list of questions or other action items related to the post-closing period, for example, that may have been submitted by any of the individual shareholders. Information such as status, date, subject, priority and who has been assigned to resolve the issue can also be displayed in such a screen.

Docket information screen 514 may contain detailed transaction information such as escrow release date 516, participating shareholder data 518, a list of transactions 520, further contact information 522, a list of activities 524, information about electronic funds transfer 526, and a way to access a variety of electronic files 526. Each of these screen includes it own series of fields and data as depicted in FIGS. 5-14.

Preferably, a system constructed in accordance with aspects of the present invention includes one or more of the following features:

1. An automated interface for tracking any dates or deadlines relevant to the period following the closing of a merger or acquisition transaction and sending automatic notices to relevant parties ahead of such dates or deadlines that such dates or deadlines are approaching.

2. The ability to automate the delivery to all or certain of the shareholders on a periodic basis a statement summarizing the current cash balances in the applicable escrow accounts and summarizing any debits or credits to such accounts over the most recent period.

3. The ability to download bank statements received from the escrow bank or escrow agent into a system that provides for the compilation and maintenance of such information for the benefit of the shareholders, and to allow for the automated breakdown of such aggregate escrow balances by shareholder. This preferably allows each shareholder to know from time to time the amount of his current portion of any such escrow accounts.

4. The ability to allow shareholders to, at their convenience, access a secured, password protected, website or other online interface to view certain information, including the balance in their respective applicable escrow accounts from time to time, update their contact information contained in the representatives' database, and post questions to the representative. In this sense a database with all relevant information is maintained which allows for the automated update and distribution of the applicable information.

5. The ability to implement a process where the representative is independent of each of the shareholders, does not have any biases or conflicts of interest with respect to the transaction or the shareholders, and takes such actions as are directed by shareholders holding a certain threshold number of shares of the sellers stock as of closing without regard to differing priorities or concerns among the shareholders.

6. Providing professional management of the process following the closing of a merger or acquisition transaction by an independent shareholder representative that specializes in the representation of shareholders specifically in connection with such issues, matters and processes as opposed to an individual shareholder less familiar with the process.

7. Providing a shareholders' representative that is insured specifically for actions taken by a shareholders' representative in order to protect the shareholders in the event that the shareholders suffer damages as a result of the shareholders' representative, or any of its agents, committing any crime, engaging in wrongdoing, or committing certain errors or omissions.

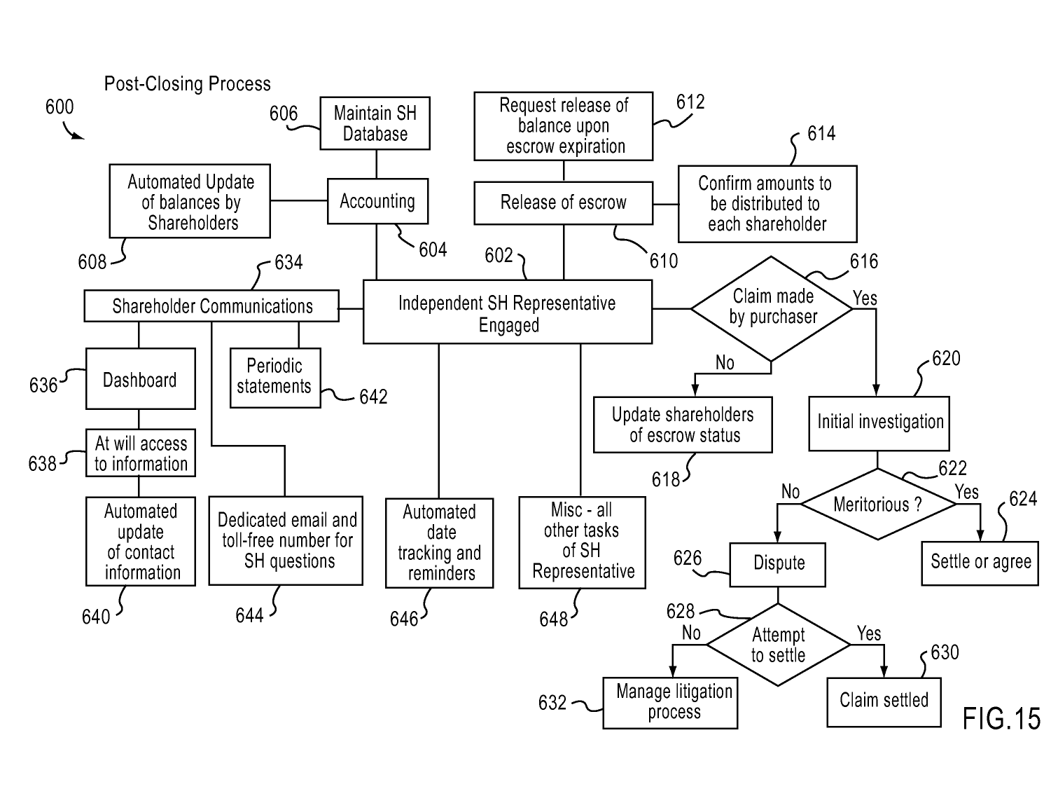

FIG. 15 shows the various services 600 that an independent shareholders' representative can provide after engagement and during the post-closing process. The chart in FIG. 15 describes in an alternative form, the features available through one or more user interfaces as described in connection with FIGS. 5-14. Referring to FIG. 15, and after the independent shareholders' representative 602 has been engaged, various activities, are coordinated through, and are performed by, the independent shareholders' representative. For example, functions such as accounting 604, release and maintenance of escrow 610, coordinating and administering any claims made by the purchaser 616, maintaining and coordinating shareholder communications 634, tracking dates and reminders 646 and any other miscellaneous tasks 648 that need to be performed by the shareholders' representative.

Accounting functions 604 performed by the shareholders' representative may include, among other typical accounting functions, the maintenance and upkeep of a shareholder database 606 and the automated update of account balances 608, preferably on a shareholder by shareholder basis. Escrow management functions 610 may include, among other typical escrow services, the process of releasing escrow funds 610 and associated functions such as responding to requests to release escrow balances upon escrow expiration 612 and the confirmation of the amounts to be distributed to each shareholder 614.

The administration of claims made by the purchaser 616 may include updating shareholders on escrow status 618 and the initiation of investigations 620 if applicable. The shareholders' representative may also make determinations as to the merits of such a claim 622, mediating and/or monitoring disputes 626, initiating settlement discussions 628, managing any litigation that might arise 632, and actually settling such disputes 630. Alternatively, the shareholders' representative may agree that the claim is meritorious and settle the claim prior to any dispute or litigation being initiated 624. In the context of any claims, the independent shareholders' representative can directly engage any specialists needed in order to determine the merits of the claim. In addition, the merits of any claims made can be completed by the independent shareholders' representative in consultation with any of the major shareholders.

The independent shareholders' representative may also monitor and control all shareholder communications 634 through the post-closing process. This may include providing access to a dashboard environment 636 that can provide at-will online access to shareholder information 638 and allow automated update of shareholder personal information such as contact information 640. Shareholder communications might also include providing periodic statements 642 as well as making available a dedicated email and toll-free phone number to address any shareholder questions 644.

In addition, automated date tracking and reminder docketing 646 and any other miscellaneous tasks 648 associated with the post-closing process can be administered through the independent shareholders' representative 602.

Although the focus of a system and method in accordance with one or more aspects of the present invention is the purchase of a privately held company with a plurality of shareholders, it is anticipated that either a publicly held company or a company with a single shareholder might need to appoint a shareholder representative. Thus, the systems and methods disclosed herein can potentially also be used in connection with a public company seller or in connection with a sale of a company with a single shareholder.

In addition, the systems and methods disclosed herein may be implemented as part of an advisory relationship to a more traditional shareholder representative (e.g. someone who is an actual shareholder or that has an equity interest in the transaction). In situations after a deal has already been signed and one of the investors has elected to be the shareholder representative, the independent shareholders' representative may use the systems and methods disclosed herein to assist the investor who is serving as the shareholder representative on this transaction in fulfilling his or her duties and obligations in such role and to help complete the post-closing process.

In conclusion, disclosed herein is a business method for representing shareholders of a privately-held company after that privately-held company has been acquired, but during the post-acquisition period where the parties to the merger and acquisition have certain obligations. Those skilled in the art will readily recognize that numerous variations and substitutions may be made in the use and its implementation of the disclosed business method to achieve substantially the same results as achieved by the implementations described herein. Accordingly, there is no intention to limit the invention to the disclosed exemplary implementations. Many variations, modifications and alternative implementations fall within the scope and spirit of the disclosed business method as expressed in the claims.

What is claimed is:

1. A method of representing shareholders of a target company in acquisition-related dealings after the target company has been acquired by or merged with or into a purchaser, the method comprising:
determining whether the target company is privately-held;
determining whether the target company has a plurality of shareholders;
if the target company is privately-held and if the target company has a plurality of shareholders, soliciting the appointment of a shareholders' representative;
entering into an agreement between the target company and the purchaser whereby the purchaser agrees to acquire or merge with the target company;
engaging the shareholders' representative to represent the plurality of shareholders of the target company in one or more acquisition-related dealings, wherein such representation begins once the target company has been acquired by or merged with or into the purchaser; and
discharging one or more duties as the shareholders' representative;
wherein the shareholders' representative is an independent entity that is not a shareholder of the target company.

2. The method of claim 1, wherein the shareholders' representative is not an officer, director, employee or affiliate of the target company.

3. The method of claim 1 further comprising granting the shareholders' representative authority to act on behalf of the plurality of shareholders in acquisition-related dealings.

4. The method of claim 1 wherein discharging one or more duties as the shareholders' representative includes representing the plurality of shareholders in negotiations related to a dispute regarding funds held in an escrow account.

5. The method of claim 1 wherein discharging one or more duties as the shareholders' representative includes representing the shareholders with respect to disputes regarding an alleged breach by the target company, by the target company's shareholders, or by both the target company and its shareholders, of a representation, of a warranty, or of a covenant related to the acquisition of the target company.

6. The method of claim 1 wherein discharging one or more duties as the shareholders' representative is selected from the group consisting of transmitting correspondence from the purchaser to the plurality of shareholders, serving as attorney-in-fact for the plurality of shareholders, communicating with the plurality of shareholders regarding acquisition-related matters, and conducting research regarding acquisition-related matters.

7. The method of claim 1 wherein discharging one or more duties as the shareholders' representative includes engaging third-party specialists, experts and/or representatives to represent and/or advise the shareholders' representative or the plurality of shareholders in disputes regarding acquisition-related matters.

8. The method of claim 1 wherein discharging one or more duties as the shareholders' representative includes monitoring one or more escrow accounts.

9. The method of claim 1 wherein engaging a shareholders' representative to represent the plurality of shareholders of the target company in acquisition-related dealings once the target company has been acquired by or merged with or into the purchaser further comprises:
entering into an agreement between the shareholders' representative and the plurality of shareholders of the target company before the target company is acquired by or merged with or into the purchaser; and
paying a fee to the shareholders' representative once the target company is acquired by or merged with or into the purchaser.

10. The method of claim 9 where the fee comprises a percentage of the acquisition price or a fixed price agreed to prior to closing.

11. The method of claim 9 wherein the target company is also a party to the agreement.

12. The method of claim 1 wherein discharging one or more duties as the shareholders' representative includes maintaining information about the shareholders of the target company, including the shareholders' names, addresses, email addresses, percentages of shareholdings, and wire transfer instructions.

13. The method of claim 12 wherein a database is utilized to maintain the information about the shareholders of the target company.

14. The method of claim 12 wherein the information about the shareholders of the target company comprises information from one or more shareholder groups.

15. The method of claim 14 wherein the information is consolidated for each shareholder group.

16. The method of claim 1 wherein discharging a plurality of duties as the shareholders' representative comprises:
recording in a data storage device a set of post-acquisition terms and conditions specified in the acquisition agreement; and
setting various reminders to monitor and track the performance of the post acquisition terms and conditions as they are specified in the acquisition agreement.

17. The method of claim 1, further comprising:
determining whether the target company is publicly-held;
if the target company is publicly-held, soliciting the appointment of a shareholders' representative.

18. The method of claim 1, further comprising, engaging the shareholders' representative to represent a single shareholder of the target company in one or more acquisition-related dealings, wherein such representation begins once the target company has been acquired by the purchaser and wherein the shareholders' representative is an independent entity that is not a shareholder of the target company.

19. A method for representing shareholders of a target company in acquisition-related dealings, wherein such representation begins after the target company has been acquired by or merged with or into a purchaser in exchange for an acquisition payment, the method comprising:
entering into an escrow agreement between the target company, the purchaser, an escrow agent, and an independent shareholders' representative, wherein the escrow agreement secures a portion of the acquisition payment in an escrow account as a security assurance to the purchaser that one or more representations and one or more warranties given by the target company to the purchaser are not breached, and that one or more covenants given by the target company to the purchaser will be executed.

20. A system for administering a post-closing escrow period by an independent shareholders' representative, comprising:
means for storing information related to at least one escrow account;
means for tracking communications between the independent shareholders' representative and at least one shareholder;
means for administering a plurality of post-closing activities related to the sale of a privately-held entity;
means for administering claims related to the at least one escrow account; and
means for collectively reporting the escrow account information, communications, post-closing activities, and claims.

21. The system of claim 20, wherein the means for collectively reporting the escrow account information, communications, post-closing activities, and claims comprises an interface adapted to provide automated date tracking and event reminders.

22. The system of claim 20, further comprising an accounting interface adapted to automatically update the account balances of at least one individual shareholder.

23. The system of claim 21, wherein the means for collectively reporting the escrow account information, communications, post-closing activities generates information that is distributed to the independent shareholders' representative on an outsourced basis.

24. A method of representing a third party shareholders' representative to assist in performing the duties and functions of service as a shareholders' representative, comprising:
storing information related to at least one escrow account;
tracking communications between the independent shareholders' representative and at least one shareholder;
administering a plurality of post-closing activities related to the sale of a privately-held entity;
administering claims related to the at least one escrow account; and
collectively reporting the escrow account information, communications, post-closing activities, and claims;
wherein the method is performed by an agent that is an independent entity that is not a shareholder of the target company.
